(19) United States
(12) Patent Application Publication
(10) Pub. No.: US 2023/0391644 A1
(43) Pub. Date: Dec. 7, 2023

(54) WASTEWATER FOAM CONTROL AGENT

(71) Applicants: Dow Silicones Corporation, Midland, MI (US); Dow Global Technologies LLC, Midland, MI (US)

(72) Inventors: Haseeb Moten, Midland, MI (US); Timothy A. Roggow, II, Chesaning, MI (US); Xue Chen, Manvel, TX (US)

(21) Appl. No.: 18/248,885

(22) PCT Filed: Oct. 21, 2021
(86) PCT No.: PCT/US2021/055935

§ 371 Date: Apr. 13, 2023

Related U.S. Application Data
(60) Provisional application No. 63/105,381, filed on Oct. 26, 2020.

(51) Int. Cl. C02F 1/68

(52) U.S. Cl. CPC C02F 1/68; C02F 2303/12; C02F 2305/04

(57) ABSTRACT

A foam control agent and method of controlling foam for wastewater treatment by use of a foam control agent, wherein the agent comprises at least a branched alcohol.

Embodiments relate to a foam control agent and method of controlling foam in waste water treatment, wherein the agent comprises at least a branched alcohol.

### INTRODUCTION

Foam in wastewater treatment plants can occur at many stages. Aeration tanks, secondary clarifiers, and the anaerobic digesters all commonly face issues with foam. This foam can take up valuable volume in the processing tanks, etc. as well as potentially spilling over creating safety and cleanup concerns.

The foam is typically generated in one of two ways, surface active agents in the wastewater or biological activity. Surface agents can be simple household detergents and cleaners, industrial surfactants or polymers, grease and oil, or a variety of other possible sources. Biological foam can be created by byproducts from microbial activity such as proteins, polysaccharide and from wastewater organisms themselves such as Nocardia.

For all these reasons and more, there is a need for a foam control agent and method of controlling foam in wastewater.

### SUMMARY

Embodiments relate to a foam control agent and method of controlling foam for wastewater treatment, wherein the agent comprises at least a branched alcohol. This organic defoamer can also boost performance of silicone defoamers.

### BRIEF DESCRIPTION OF THE DRAWINGS

Various embodiments are disclosed in the following detailed description and accompanying drawings:

FIG. 1 is a diagram of pump test components

### DETAILED DESCRIPTION

The present disclosure relates to a foam control agent for wastewater treatment. The present disclosure details how, unexpectedly, branched alcohols have been shown to have superior foam control performance. The branched alcohols may be 2-alkyl-1-alkanols (also known as Guerbet alcohols), and preferably 2-ethylhexanol (2-EH) and 2-propylheptanol (2-PH). These alcohols can be synthesized via the aldol condensation of the corresponding aldehydes or from the Guerbet reaction of primary linear alcohols. Other methods of production may also be utilized.

In this invention, C9 to C12 β-branched alcohols (C9-C12 Guerbet alcohols) were found to be surprisingly effective in reducing the foam during the various stages of wastewater treatment. Another benefit to the branched alcohols is their very good biodegradability.

The generic structure of the antifoaming agent currently disclosed is as follows:

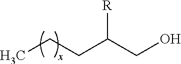

wherein x is an integer from 2 to 8 and R is an alkyl group with 1-8 carbon atoms.

The foam control agent may also be described as comprising a 2-alkyl substituted alcohol from C9-C12. The alcohols can be predominately one isomer (>95 wt. %) or a mixture of alcohols which can be generated by an aldol condensation of a mixture of aldehydes or generated from a mixture of alcohols via the Guerbet reaction.

The C8-C32 Guerbet alcohols including 2-ethylhexanol, 2-butyl-1-octanol, and 2-propylheptanol and the mixture of C8, C9, and C10 alcohols generated from the aldol condensation of butyraldehyde and valeraldehyde are preferred in some embodiments.

The concentration of the Guerbet alcohol in the formulated foam control agent ranges from 0.01% to 100%, preferably, ranging from 25% to 100% when used as antifoaming agent or as a defoaming agent. The Guerbet alcohol can be in the form of a solid or liquid, a liquid is preferred. If it is a solid, the material may be dissolved or dispersed in a solvent. The said foam control agent can be aqueous solution or organic solvent-based solution. The usage dosage of the said foam control agent for wastewater treatment varies from 0.01% to 5%, preferably, ranges from 0.1% to 1% (50-100 ppm).

Other foam control agents (e.g., copolymers composed of ethylene oxide, propylene oxide, and/or butylene oxide, random or blocks) or other hydrophobic materials such as waxes, oils or silicas may also be added with the branched, Guerbet alcohol(s). Silicone can be used in conjunction with the 2-alkyl alcohols. Surfactants, especially alkoxylates of the alcohols can also be used. The use of branched alcohols as foam control agents may be water based or oil based.

The new foam control agent presently disclosed may be in the form of a solid or liquid. If it is a solid, the material may be dissolved or dispersed in a solvent before use as a foam control agent. The presently disclosed agents are believed to work in the presence of all commonly used industrial cleaners.

The chemical agent can be used both in antifoamer or defoamer formulations. Antifoamer formulations are obtained by the mixture of polyglycols, esters, silicones, solvents, water and other chemicals that in the gas-liquid interface of the bubble avoiding the foam formation. Other amphiphilic chemicals based on block copolymer can be used as well. In defoaming formulations, in addition to the products mentioned above, it can be used vegetal oils, mineral oils, waxes and other oily agents.

The optional surfactant or emulsifier contained in the foam control agent is selected to be suitable for improving the compatibility of the foam control agent on the feedstock or forming an emulsion with the composition of branched alcohol. The optional surfactant or emulsifier has an amount ranging from 0.1-30% by weight of the composition of branched alcohol.

The optional surfactant or emulsifier may be anionic, cationic or nonionic. Examples of suitable anionic surfactants or emulsifiers are alkali metal, ammonium and amine soaps; the fatty acid part of such soaps contains preferably at least 10 carbon atoms. The soaps can also be formed “in situ;” in other words, a fatty acid can be added to the oil phase and an alkaline material to the aqueous phase.

Other examples of suitable anionic surfactants or emulsifiers are alkali metal salts of alkyl-aryl sulfonic acids, sodium dialkyl sulfosuccinate, sulfated or sulfonated oils, e.g., sulfated castor oil; sulfonated tallow, and alkali salts of short chain petroleum sulfonic acids.

Suitable cationic surfactants or emulsifiers are salts of long chain primary, secondary or tertiary amines, such as oleylamide acetate, cetylamine acetate, di-dodecylamine lactate, the acetate of aminoethyl-aminoethyl stearamide, dilauroyl triethylene tetramine diacetate, 1-aminoethyl-2-heptadecenyl imidazoline acetate; and quaternary salts, such as cetylpyridinium bromide, hexadecyl ethyl morpholinium chloride, and diethyl di-dodecyl ammonium chloride.

Examples of suitable nonionic surfactants or emulsifiers are condensation products of higher fatty alcohols with ethylene oxide, such as the reaction product of oleyl alcohol with 10 ethylene oxide units; condensation products of alkylphenols with ethylene oxide, such as the reaction product of isoctylphenol with 12 ethylene oxide units; condensation products of higher fatty acid amides with 5, or more, ethylene oxide units; polyethylene glycol esters of long chain fatty acids, such as tetraethylene glycol monopalmitate, hexaethyleneglycol monolaurate, nonaethyleneglycol monostearate, nonaethyleneglycol dioleate, tridecaethyleneglycol monoarachidate, tricosaethyleneglycol monobehenate, tricosaethyleneglycol dibehenate, polyhydric alcohol partial higher fatty acid esters such as sorbitan tristearate, ethylene oxide condensation products of polyhydric alcohol partial higher fatty acid esters, and their inner anhydrides (mannitol-anhydride, called Mannitan, and sorbitol-anhydride, called Sorbitan), such as glycerol monopalmitate reacted with 10 molecules of ethylene oxide, pentaerythritol monooleate reacted with 12 molecules of ethylene oxide, sorbitan monostearate reacted with 10-15 molecules of ethylene oxide, mannitan monopalmitate reacted with 10-15 molecules of ethylene oxide; long chain polyglycols in which one hydroxyl group is esterified with a higher fatty acid and other hydroxyl group is etherified with a low molecular alcohol, such as methoxypolyethylene glycol 550 monostearate (550 meaning the average molecular weight of the polyglycol ether). A combination of two or more of these surfactants may be used; e.g., a cationic may be blended with a nonionic or an anionic with a nonionic.

The foam control agent may further comprise one or more additives. Examples of additives include ethylene oxide/propylene oxide block copolymers, butylene oxide/propylene oxide block copolymers, ethylene oxide/butylene oxide block copolymers, waxes, or silicone-based materials. For other wastewater treatment applications where surfactants cause foaming in the treatment steps, higher 2-alkyl substituted alcohols up to C32 can be used.

### EXAMPLES

An experiment to test the efficacy of the presently disclosed foam control agent and others may be conducted as follows.

### Materials

TABLE 1
Raw Materials

| Name | Producer/Vendor | Function | Chemistry and function |
|---|---|---|---|
| 2-ethylhexanol | Purchased from | Novel Foam Control | |
| (2-EH) | Sigma Aldrich | Agent | |
| 2-Propylheptanol | Purchased from | Novel Foam Control | |
| (2-PH) | Sigma Aldrich | Agent | |
| Xiameter ACP- | Dow Chemical | Comparative example | Silicone based foam control agent |
| 1400 Antifoam | | benchmark | |
| Compound | | | |
| Propylene Glycol | Purchased from Sigma Aldrich | Diluent for silicone compounds | 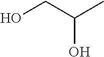 |
| Triton X-100 | Dow Chemical | Foam medium for test | |

TABLE 2
Test Formulations

| | Foam control | Test | | | Foaming |
|---|---|---|---|---|---|
| Examples | Agent | Method | Amount | Actives Concentration | Medium |
| Example 1 | 2-Propylheptanol | Pump | 2 ml | 2500 ppm | 1% Triton |
| | | Test | | | X-100 |
| Example 2 | 2-Propylheptanol | Pump | 4 ml | 5000 ppm | 1% Triton |
| | | Test | | | X-100 |
| Example 3 | 2-Propylheptanol | Pump | 50 uL 2- | 10 ppm ACP 1400 + | 1% Triton |
| | and ACP-1400 | Test | Propylheptanol | 62.5 ppm 2PH | X-100 |
| | | | 8 uL | | |
| | | | ACP-1400 | | |
| | | | 792 uL | | |
| | | | propylene | | |
| | | | glycol | | |
| Example 4 | 2-Propylheptanol | Shake | 100 μl | 1000 ppm | 1% Triton |
| | | Test | | | X-100 |
| Example 5 | 2-Propylheptanol | Shake | 50 uL 2- | 20 ppm ACP 1400 + | 1% Triton |
| | and ACP-1400 | Test | Propylheptanol | 500 ppm 2PH | X-100 |
| | | | 0.002 g | | |
| | | | ACP-1400 | | |
| | | | 0.498 g | | |
| | | | propylene | | |
| | | | glycol | | |
| Example 6 | 2-Propylheptanol | Shake | 100 uL 2- | 20 ppm ACP 1400 + | 1% Triton |
| | and ACP-1400 | Test | Propylheptanol | 1000 ppm 2PH | X-100 |
| | | | 0.002 g | | |
| | | | ACP-1400 | | |
| | | | 0.498 g | | |
| | | | propylene | | |
| | | | glycol | | |
| Example 7 | Ethylhexanol | Shake | 500 uL | 5000 ppm EH | 1% Triton |
| | | Test | Ethylhexanol | | X-100 |
| Example 8 | Ethylhexanol and | Shake | 100 uL 2- | 50 ppm ACP 1400 + | 1% Triton |
| | ACP-1400 | Test | Propylheptanol | 1000 ppm EH | X-100 |
| | | | 0.005 g | | |
| | | | ACP-1400 | | |
| | | | 0.495 g | | |
| | | | propylene | | |
| | | | glycol | | |
| Comparative | ACP 1400 | Pump | 8 uL | 10 ppm | 1% Triton |
| Example 1 | | Test | ACP-1400 | | X-100 |
| | | | 792 uL | | |
| | | | propylene | | |
| | | | glycol | | |
| Comparative | ACP 1400 | Shake | 0.002 g | 20 ppm | 1% Triton |
| Example 2 | | Test | ACP-1400 | | X-100 |
| | | | 0.498 g | | |
| | | | propylene | | |
| | | | glycol | | |
| Comparative | ACP 1400 | Shake | 0.005 g | 50 ppm | 1% Triton |
| Example 3 | | Test | ACP-1400 | | X-100 |
| | | | 0.495 g | | |
| | | | propylene | | |
| | | | glycol | | |

### Testing Methodology

### Pump Test

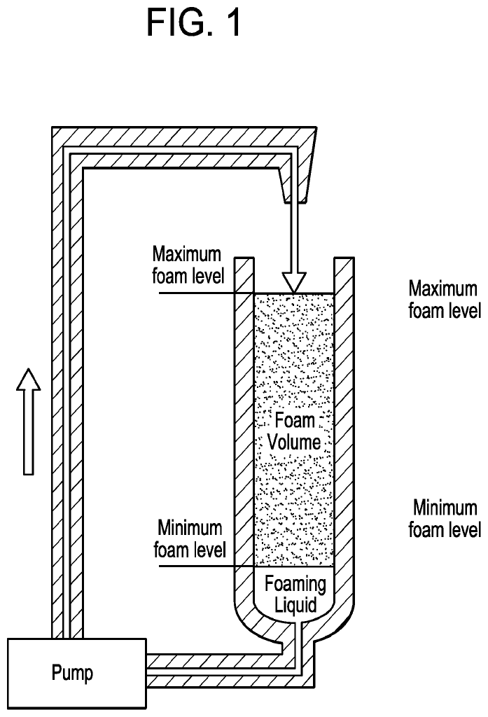

To test the foam control performance, a pump test was utilized. The pump test is composed of three components: a 2 L clear jacketed glass open top glass column with a valve at the bottom. A cell heater recirculating silicone fluid through the jacket to maintain temperature. A centrifugal pump with the inlet attached to the bottom valve of the column and the outlet going into the top of the open glass column to recirculate the foaming medium. FIG. 1 is a diagram of the pump test components.

For this test, the foaming medium was carefully poured into the 2 L glass column that had been preheated to 25C. The antifoaming agent(s) were then prepared by mixing 0.2 grams of silicone antifoam with 49.8 grams of propylene glycol (mixed via shaking in a bottle). Propylheptanol and ethyl hexanol were used neat in this test and all the antifoaming agents were loaded into micropipettes.

The recirculating pump was then turned on and the foam generated by the pump monitored until it the foam reaches a height of 1700 mL in the column. At this point the antifoam was injected directly into the recycle stream. In the examples where a combination of alcohol and silicone were utilized, both were injected simultaneously using two micropipettes into the recycle stream. The Foam Volume was then monitored until foam returns to the maximum 1700 mL level or ten minutes have passed, whichever comes first.

### Shake Test

To further test the foam control performance, a shake test was conducted. For this test, a Burrell WRIST-ACTION Model AA, equipped with a suitable clamp to accommodate an 8 oz (240 mL) French Square bottle was utilized (Burrell Corp., Pittsburgh, PA, Cat. No. 75-755-04). The shaker arm measured 5¼+/− 1/16 in. (13.34+/−0.16 cm). This is measured from the center of the shaker shaft to the center of the bottle. The shaker arm was horizontal in the rest position to hold the bottle in a vertical position. The shaking arc was around 16 degrees and the shaking frequency was around 350 strokes per minute.

For this test, the following steps took place. First, 100 mL of the foaming medium(s) were poured into 8 oz French Square bottle. For the samples which utilized a silicone antifoam compound, these samples were diluted using propylene glycol. For a 20 PPM test, 0.2 grams of silicone compound was combined with 49.8 grams of propylene glycol and mixed thoroughly by shaking. For a 50 PPM test, 0.5 grams of silicone compound was mixed with 49.5 grams of propylene glycol and mixed thoroughly by shaking.

0.5 grams of the silicone compound and propylene glycol mixture were then added to the surface of 1% Triton X-100 solution (in the bottle). The required amount of propylheptanol or ethyl hexanol (when used) was then directly added to the surface of the solution (in the bottle). The French bottle was then capped and placed in the clamp on the shaker arm for agitation/mixing. The shaker was then turned on for 30 seconds and after shaking stops, a time until foam collapses (when the foam height has fallen to 0.5 cm or below over the majority of the surface) was recorded.

### Results

Foam control performance for the foam control agents are shown in Tables 3-4. As shown in Tables 3-4, 0.25% (2500 ppm) 2-PH and 0.5% (5000 ppm) 2-PH in 1% Triton X-100 provide a significant improvement in foam knock down compared to the silicone-based foam control agent 1400 in propylene glycol. The 2-PH alcohol also presents good persistence performance The addition of 2-PH to the silicone antifoamers also results in improved knockdown compared with the silicone-based foam control agent in propylene glycol.

TABLE 1
Experimental results for pump test in 1% Triton X-100

| | | | Example 3 | Comparative |
|---|---|---|---|---|
| | Example 1 | Example 2 | 62.5 PPM | Example 1 |
| | 2500 PPM | 5000 PPM | 2PH + 10 PPM | 10 PPM |
| Examples | 2PH | 2PH | ACP 1400 | ACP 1400 |
| Name | Foam | Foam | Foam | Foam |
| Time | Volume | Volume | Volume | Volume |
| (seconds) | (mL) | (mL) | (mL) | (mL) |
| 0 | 1000 | 1000 | 1000 | 1000 |
| 5 | 840 | 540 | 600 | 800 |
| 10 | 660 | 360 | 660 | 880 |
| 15 | 620 | 340 | 720 | 920 |
| 20 | 600 | 320 | 760 | 960 |
| 25 | 620 | 340 | 800 | 1040 |
| 30 | 620 | 340 | 900 | 1040 |
| 35 | 640 | 340 | 1000 | 1020 |
| 40 | 680 | 340 | 1100 | 1020 |
| 45 | 720 | 340 | 1200 | 1040 |
| 50 | 760 | 340 | | 1100 |
| 55 | 780 | 340 | | 1100 |
| 60 | 780 | 340 | | 1140 |
| 70 | 800 | 340 | | 1180 |
| 80 | 840 | 340 | | 1200 |
| 90 | 880 | 340 | | |
| 100 | 940 | 340 | | |
| 110 | 960 | 340 | | |
| 120 | 1000 | 340 | | |
| 130 | 1080 | 340 | | |
| 140 | | 340 | | |
| 150 | | 340 | | |
| 160 | | 340 | | |
| 170 | | 340 | | |
| 180 | | 340 | | |
| 190 | | 340 | | |
| 200 | | 340 | | |
| 210 | | 340 | | |
| 220 | | 340 | | |
| 230 | | 340 | | |
| 240 | | 340 | | |
| 250 | | 340 | | |
| 260 | | 340 | | |
| 270 | | 340 | | |
| 280 | | 340 | | |
| 290 | | 340 | | |
| 300 | | 340 | | |
| 310 | | 340 | | |
| 320 | | 340 | | |
| 330 | | 340 | | |
| 340 | | 340 | | |
| 350 | | 340 | | |
| 360 | | 340 | | |
| 370 | | 340 | | |
| 380 | | 340 | | |
| 390 | | 340 | | |
| 400 | | 340 | | |
| 410 | | 340 | | |
| 420 | | 340 | | |
| 430 | | 340 | | |
| 440 | | 340 | | |
| 450 | | 340 | | |
| 460 | | 340 | | |
| 470 | | 340 | | |
| 480 | | 340 | | |
| 490 | | 340 | | |
| 500 | | 340 | | |
| 510 | | 340 | | |
| 520 | | 340 | | |
| 530 | | 340 | | |
| 540 | | 340 | | |
| 550 | | 340 | | |
| 560 | | 340 | | |
| 570 | | 340 | | |
| 580 | | 340 | | |
| 590 | | 340 | | |
| 600 | | 340 | | |

TABLE 4
Experimental results for shake test in 1% Triton X-100

| | Examples | | | | | | |
|---|---|---|---|---|---|---|---|
| | | | | | | Comparative | Comparative |
| | Example 4 | Example 5 | Example 6 | Example 7 | Example 8 | Example 2 | Example 3 |
| | Name | | | | | | |
| | | 20 PPM ACP | 20 PPM ACP | | 50 PPM ACP | | |
| | 1000 PPM | 1400 + 500 PPM | 1400 + 1000 PPM | 5000 PPM | 1400 + 1000 PPM | 20 PPM | 50 PPM |
| | 2 PH | 2 PH | 2 PH | EH | EH | ACP 1400 | ACP 1400 |
| | Collapse | Collapse | Collapse | Collapse | Collapse | Collapse | Collapse |
| Cycle | Time (s) | Time (s) | Time (s) | Time (s) | Time (s) | Time (s) | Time (s) |
| 1 | 23.57 | 5.66 | 7.94 | 6.95 | 3.84 | 17.39 | 15.03 |
| 2 | 300 | 26.73 | 22.64 | 300 | 17.72 | 29.61 | 20.98 |
| 3 | | 28.47 | 30.05 | | 22.81 | 41.16 | 21.88 |
| 4 | | 45.66 | 40.82 | | 31.16 | 66.11 | 31.3 |
| 5 | | 39.24 | 35.51 | | 23.65 | 76.76 | 37.19 |
| 6 | | 31.14 | 33.64 | | 29.46 | 132.89 | 52.21 |
| 7 | | 51.15 | 32.64 | | 36.4 | 300 | 73.74 |
| 8 | | 40.39 | 39.61 | | 36.16 | | 190.23 |
| 9 | | 54.84 | 42.41 | | 41.34 | | 300 |
| 10 | | 80.73 | 39.02 | | 48.34 | | |
| 11 | | 300 | 46.19 | | 53.85 | | |
| 12 | | | 58.54 | | 65.87 | | |
| 13 | | | 73.08 | | 85.14 | | |
| 14 | | | 111.24 | | 300 | | |

1. (canceled)

2. (canceled)

3. (canceled)

4. (canceled)

5. A method of controlling foam for wastewater treatment by use of a foam control agent, wherein the agent comprises at least a branched alcohol that has the structure of: 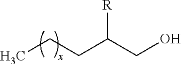
wherein x is an integer from 2 to 8 and R is an alkyl group with 1-8 carbon atoms, wherein the alcohol has from 9 to 12 carbon atoms.

6. The method of claim 5, wherein at least one other foam control agent or hydrophobic material is added.

7. The method of claim 5, wherein a silicone is also added.

8. (canceled)
